(19) United States
(12) Patent Application Publication
(10) Pub. No.: US 2003/0095086 A1
(43) Pub. Date: May 22, 2003

(54) Circuit configuration for driving a set of at least one light-emitting diode

(76) Inventors: Juergen Neuhaeusler, Bad Aibling/Willing (DE); Oliver Nachbaur, Muenchen (DE)

Correspondence Address: TEXAS INSTRUMENTS INCORPORATED, P O BOX 655474, M/S 3999, DALLAS, TX, 75265

(21) Appl. No.: 10/251,573

(22) Filed: Sep. 20, 2002

(30) Foreign Application Priority Data
Sep. 21, 2001 (DE) 101 46 597.1

(51) Int. Cl. G09G 3/32

(52) U.S. Cl. 345/82

(57) ABSTRACT

A circuit configuration for driving a light-emitting diode (D1 to D6) by means of a current provided by a supply voltage source (12) includes an inductance (14) connected in series between the supply voltage source (12) and the LED (D1 to D6). A switch (16) that can be either in the open or in the closed position and that is connected between the junction of the inductance (14) with the LED (D1 to D6) and ground, which, when in the closed position, short-circuits the LED (D1 to D6). A control circuit (18) which takes the switch (16) into its open position when the current flowing through the inductance (14) has risen to a pre-determined value, and which takes the switch (16) into its closed position when the current through the LED (D1 to D6), or the voltage across the LED (D1 to D6), has fallen to a pre-determined value.

### FIELD OF THE INVENTION

The invention relates to a circuit configuration for driving at least one light-emitting diode by a current provided by a supply voltage source.

### BACKGROUND OF THE INVENTION

Light-emitting diodes are used to a large extent as light sources for the background illumination of liquid crystal displays. Typically, LCDs are used in electronic devices, such as mobile telephones, which rely for their energy supply on a battery which can provide only a relatively low supply voltage. If this supply voltage is lower than the forward voltage of the light-emitting diodes, special circuit-related measures must be taken to generate these higher voltages required to drive the light-emitting diodes. This applies in particular to light-emitting diodes producing white light, where the forward voltage is in the region of the voltage provided by the batteries in current use, or even higher. This means that, in order to drive such white-light-emitting diodes, DC-DC converters have to be used which can provide these higher voltages. This problem presents itself especially when not only one light-emitting diode but, as in the case of background illumination, several light-emitting diodes are connected in series to achieve the most even illumination of a liquid crystal display (LCD).

### SUMMARY OF THE INVENTION

The invention addresses the requirement of providing a circuit configuration of the type previously described, that makes it possible to drive light-emitting diodes from a voltage source whose voltage is not higher than the forward voltage of the LEDs to be driven, without the need for complex circuitry.

In accordance with the invention, this requirement is satisfied in a circuit configuration of the type previously indicated by providing an inductance connected in series between the supply voltage source and the set of at least one LED, a switch that can be either in the open or in the closed position and that is connected between the junction of the inductance with the set of at least one LED and ground, which, when in the closed position, short-circuits the set of at least one LED, and a control circuit which takes the switch into its open position when the current flowing through the inductance has risen to a pre-determined value, and which takes the switch into its closed position when the current through the set of at least one LED, or the voltage across the set of at least one LED, has fallen to a pre-determined value.

The circuit configuration makes use of the fact that when the current flowing through an inductance is interrupted, the energy stored in it causes the generation of a voltage that reaches considerably higher values than the voltage of the supply source which was the cause of the current flowing through the coil. This increased voltage is then used to drive the set of at least one LED, so that it can be put to use as intended.

### BRIEF DESCRIPTION OF THE DRAWINGS

FIG. 1 illustrates the circuit of the present invention.

### DETAILED DESCRIPTION OF THE DRAWINGS

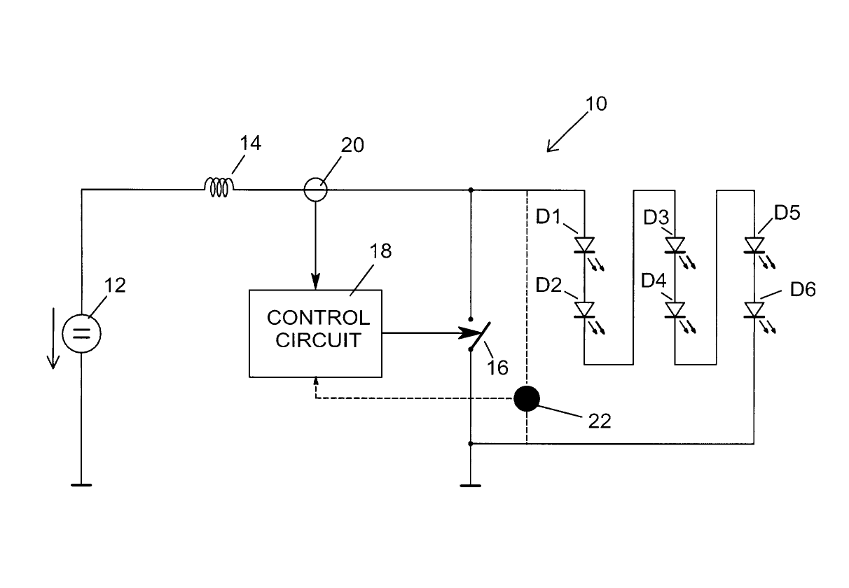

The invention shall now be explained in exemplified form with reference to the drawing where FIG. 1 shows the schematic circuit diagram of the circuit configuration according to the invention.

The circuit configuration 10 comprises a voltage source 12 which provides the supply voltage U. The current from this voltage source 12 flows through an inductance 14 and a chain of series-connected LEDs D1 to D6 to ground. Between the junction point of the inductance 14 and the LEDs D1 to D6 and ground, a switch 16 is provided which can be made to alternate between the positions closed and open by means of a signal generated by the control circuit 18.

As can be appreciated, when the switch 16 is in its open position, current can flow through the inductance 14 and the LEDs D1 to D6 to ground, while when the switch 16 is in its closed position, the LED chain is short-circuited, so allowing the current from the supply voltage source 12 to flow through the inductance 14 and the closed switch 16 directly to ground. By controlling the magnitude of the current, the brightness of the light emitted by the LEDs can be adjusted as desired.

The circuit configuration includes a current measuring device 20 by means of which, as a function of the position of the switch 16, either the current flowing through the inductance 14 and the series-connected LEDs D1 to D6 (switch open), or just the current flowing through the inductance 14 (switch closed) can be measured. As shall be explained later on, the switch 16 is taken into either the open or into the closed position by the control circuit 18 as a function of the current values measured.

The circuit configuration represented in the drawing operates as follows: When the circuit configuration 10 is brought into operation, the control circuit 18 initially takes the switch 16 into its closed position. In this position, the LEDs D1 to D6 are short-circuited, and the current can only flow through the inductance to ground. This current is measured by the current meter 20. The current can, for example, also be measured by inserting a resistor in place of the current meter 20, where the voltage drop across this resistor will then be directly proportional to the current flowing in the current path.

As soon as the measured current (or the corresponding voltage drop, if a resistor is used instead of the current measuring device 20) reaches a predetermined value, the control circuit 18 takes the switch 16 into its open position. The pre-determined current value can, for example, be the maximum current flow value to be reached, or also an average value.

As the switch 16 is taken into its open position, the current flow through the inductance 14 is interrupted. The magnetic energy stored in the inductance 14, however, causes the voltage at the end of the inductance 14 that is connected to the LEDs D1 to D6 to rise until the LEDs become conductive and start emitting light. The voltage, in this case, can rise considerably above that of the voltage of the supply source 12. In this way it is assured that a voltage higher than their forward voltage can be generated at the LEDs D1 to D6, even if the voltage provided by the supply voltage source 12 is lower than their forward voltage. As soon as the current value measured by the current measuring device 20 has gone down to zero or to a pre-determined low value, the control circuit 18 again takes the switch 16 into its closed position, so that the current can now only flow through the inductance 14, so as to restore the magnetic energy stored in it. The change-over processes of the switch 16 under the control of the control circuit 18 will then be repeated periodically.

By dimensioning the components used in the circuit configuration in a suitable way, it becomes possible that the switch-over sequence of the switch 16 takes place at a frequency so high that the current interruptions in the current path to the LEDs D1 to D6 and, consequently, the emission of light by these LEDs will not be perceptible by the human eye.

As an alternative to controlling the closing point of the switch 16, it is also possible to measure to voltage present across the LEDs D1 to D6, as is indicated in the diagram by the broken lines connecting the voltage measuring device 22. When this alternative option is used, the change-over switch 16 will always be taken into its closed position by he control circuit 18, whenever the voltage across the LEDs D1 to D6 falls to zero or to a pre-determined low value.

As has been shown, the circuit configuration as described makes it possible to drive LEDs whose forward voltage is equal to or greater than the voltage provided by a supply voltage source, without there being any need to use additional circuitry, such as DC-DC transformers, to increase the driving voltage level. For example, this circuit arrangement makes it possible for white LEDs of 3.6 to 4.0 V forward voltages to be driven by a 3.6 V lithium cell.

1. A circuit for driving at least one light-emitting diode by a current provided by a supply voltage source, comprising:
an inductance (14) connected in series between the supply voltage source (12) and at least one LED (D1 to D6),
a switch (16) connected between the junction of the inductance (14) with the at least one LED (D1 to D6) and ground, which, short-circuits the at least one LED (D1 to D6), and
a control circuit (18) which controls the switch (16) to open when the current flowing through the inductance (14) has risen to a pre-determined value, and controls the switch to close when the current through of at least one LED (D1 to D6), or the voltage across of at least one LED (D1 to D6), has fallen to a pre-determined value.

2. A circuit according to claim 1, where it is used to drive at least two of said LED (D1 to D6), connected in series, which provide the background illumination for a liquid crystal display (LCD).
